(19) United States
(12) Patent Application Publication
(10) Pub. No.: US 2013/0329987 A1
(43) Pub. Date: Dec. 12, 2013

(54) VIDEO SEGMENTATION METHOD

(71) Applicant: Minglun GONG, St. John's (CA)

(72) Inventor: Minglun GONG, St. John's (CA)

(73) Assignee: GENESIS GROUP INC., St. John's (CA)

(21) Appl. No.: 13/493,482

(22) Filed: Jun. 11, 2012

(51) Int. Cl. G06K 9/62

(52) U.S. Cl. 382/159

(57) ABSTRACT

A system and method implemented as a software tool for foreground segmentation of video sequences in real-time, which uses two Competing 1-class Support Vector Machines (C-1SVMs) operating to separately identify background and foreground. A globalized, weighted optimizer may resolve unknown or boundary conditions following convergence of the C-1SVMs. The objective of foreground segmentation is to extract the desired foreground object from live input videos, with fuzzy boundaries captured by freely moving cameras. The present disclosure proposes the method of training and maintaining two competing classifiers, based on Competing 1-class Support Vector Machines (C-1SVMs), at each pixel location, which model local color distributions for foreground and background, respectively. By introducing novel acceleration techniques and exploiting the parallel structure of the algorithm (including reweighing and max-pooling of data), real-time processing speed is achieved for VGA-sized videos.

### FIELD

The present application relates to methods and systems for image and video processing, and in particular, methods and systems for extracting foreground objects from video sequences.

### BACKGROUND

Real-time foreground segmentation for live video relates to methods and systems for image and video processing, and in particular, methods and systems for extracting foreground objects from live video sequences, even where the boundaries between the foreground objects and the background regions are complicated by multiple closed regions, partially covered pixels, similar background colour, similar background textures, etc., in a computationally efficient manner so as to permit so-called “real-time” operation.

Foreground segmentation, also referred to as video cutout, is the extraction of objects of interest from input videos. It is a fundamental problem in computer vision and often serves as a pre-processing step for other video analysis tasks such as surveillance, teleconferencing, action recognition and retrieval. A significant number of techniques have been proposed in both computer vision and graphics communities. However, some of them are limited to sequences captured by stationary cameras, whereas others require large training datasets or cumbersome user interactions. Furthermore, most existing algorithms are rather complicated and computationally demanding. As a result, there is still lacking an efficient yet powerful algorithm that can process challenging live video scenes with minimum user interactions.

There is a need for a system and method for foreground segmentation which is both robust, and computationally efficient.

Existing approaches to foreground segmentation may be categorized as unsupervised and supervised.

Unsupervised approaches, try to generate background models automatically and detect outliers of the models as foreground. Most of them, referred to as background subtraction approaches, assume that the input video is captured by a stationary camera and model background colors at each pixel location using either generative methods (e.g.: J. Zhong and S. Sclaroff, Segmenting foreground objects from a dynamic textured background via a robust Kalman filter, ICCV, 2003 [Zhong 1]; or J. Sun, W. Zhang, X. Tang, and H. Shum, Background cut, ECCV, 2006 [Sun 2]) or nonparametric methods (for example: Y. Sheikh and M. Shah. Bayesian object detection in dynamic scenes, CVPR, 2005 [Sheikh 3]; or J. Wang, P. Bhat, A. Colburn, M. Agrawala, and M. Cohen, Interactive video cutout, SIGGRAPH, 2005 [Wang 4]). Some of these techniques can handle repetitive background motion, such as rippling water and waving trees, but are unsuitable for a camera in motion.

Considering existing unsupervised methods where camera motion does not change the viewing position, such as PTZ security cameras, the background motion has been described by a homography, which has been used to align different frames before applying the conventional background subtraction methods (e.g. E. Hayman and J. Eklundh, Statistical background subtraction for a mobile observer, ICCV, 2003 [Hayman 5]). The method of Y. Sheikh, O. Javed, and T. Kanade, Background subtraction for freely moving cameras, ICCV, 2009 [Sheikh 6], proposed to deal with freely moving cameras by means of tracking the trajectories of salient features across the whole video, where the trajectories are used for estimating the background trajectory space, based on which foreground feature points can be detected accordingly. While this method automatically detects moving objects, it tends to classify background with repetitive motion as foreground, as well as to confuse large rigidly moving foreground objects with background.

Supervised methods allow users to provide training examples to train the segmentation method being employed. Certain existing methods (for example: V. Kolmogorov, A. Criminisi, A. Blake, G. Cross, and C. Rother, Bilayer segmentation of binocular stereo video, CVPR, 2005 [Kolmogorov 7]; A. Criminisi, G. Cross, A. Blake, and V. Kolmogorov, Bilayer segmentation of live video, CVPR, 2006 [Criminisi 8]; and P. Yin, A. Criminisi, J. Winn, and I. Essa, Tree-based classifiers for bilayer video segmentation, CVPR, 2007 [Yin 9]) integrate multiple visual cues such as color, contrast, motion, and stereo with the help of structured prediction methods such as conditional random fields. Although operational for video conferencing applications, these algorithms require a large set of fully annotated images and considerable offline training, which bring up many issues when attempting to apply them in different scene setups.

Some existing matting algorithms also provide supervised foreground segmentation by modelling the video sequence as a 3D volume of voxels. Users are required to label fore/background on multiple frames or directly on the 3D volume. To enforce temporal coherence, these algorithms usually segment over the entire volume at one time, which restricts their capacity toward live video processing.

The Video Snap-Cut by X. Bai, J. Wang, D. Simons, and G. Sapiro, Video snapcut: robust video object cutout using localized classifiers, SIGGRAPH, 2009 [Bai 10], is one existing technique, starting from a segmentation of the first frame, both global and local classifiers are trained using color and shape cues, then labelling information is propagated to the rest of the video frame by frame. Video SnapCut expects users to provide a fine annotation of the entire first frame which can be challenging for fuzzy objects, and runs at about 1 FPS for VGA-sized videos (excluding the time for matting).

There is a need for a robust, minimally supervised video segmentation technique which is able to operate in real time, and which is able to handle freely moving cameras and/or background images.

There is a need for a video segmentation technique designed for parallel computing which is both easy to implement and has low computation cost, that is capable of dealing with challenging video segmentation scenarios with minimal user interaction.

### SUMMARY

This present application relates to a foreground/background segmentation approach that is designed for parallel computing, is both easy to implement and has low computation cost, and is capable of dealing with challenging video segmentation scenarios with minimal user interaction. As shown in FIG. 1, with only a few strokes from user on the first frame of the video, the preferred embodiment of the present invention is able to propagate labelling information to neighbouring pixels through a simple train-relabel procedure, resulting in a proper segmentation of the frame. This same procedure is used to further propagate labeling information across adjacent frames, regardless the fore/background motion. Several techniques are also proposed in order to reduce computational costs. Furthermore, by exploiting the parallel structure of the proposed algorithm, real-time processing speed of 14 frames per second (FPS) is achieved for VGA-sized videos.

A number of improvements are proposed. First, the segmentation method maintains two Competing 1-class Support Vector Machines (C-1SVMs) at each pixel location, rather than operating a single classifier. A first competing 1-class Support Vector Machines (C-1SVM) captures the local foreground color densities and a second competing 1-class Support Vector Machines (C-1SVM) captures the local background color densities separately from the first C-1 SVM. However, the two C-1SVM's determine the proper foreground/background label for the pixel jointly. Through iterations between training local C-1SVMs and applying them to label the pixels, the algorithm can effectively propagate \ initial user labeling to the whole image and to consecutive frames. The frame/image is partitioned into known foreground (if the foreground-1SVM says foreground and the background-1SVM says not background), known background (if the foreground-1SVM says not foreground and the background-1SVM says background) and unknown (if the foreground a-SVM and background-1SVM disagree as to classification). Then, optionally, the unknown pixels are forced to either foreground or background by a smoothing function. The smoothing function disclosed in Algorithm 2 below is a globally optimized thresholded costing function biased towards foreground identification. On a step-wise basis as frames advance, the edges of the foreground and background are eroded, and the impact of older frames on the support vectors for individual pixels attenuated in time.

Choice of grid sizes, and novel approaches to structuring the grid for computational purposes provide optional advantages. In general, each pixel may be trained to the algorithm using its own neighbourhood of sufficient size, which may be augmented by training based on the centre points of one or more neighbourhoods elsewhere within the image. In different approaches shown: (i) a pixel may be trained to the algorithm with reference to all pixels within a shape about the pixel; (ii) a pixel may be trained with reference to all the pixels within its neighbourhood and then with the middle pixels in adjacent neighbourhoods of similar size; or even (iii) a pixel may be trained with reference to its neighbourhood and the centre points of neighbourhoods of similar size not full adjacent to the neighbourhood of the pixel, but separated by some known distance in a pseudo adjacency. Furthermore, by exploiting the parallel structure of the proposed algorithm, and appropriate grid spacing and sizes, real-time processing speed of 14 frames per second (FPS) is achieved for VGA-sized videos.

The steps of the segmentation method disclosed in this application can be summarized with reference to FIG. 11 as follows:

Step 1: the design parameters of the 1-class support vector machines (1SVM) to be used to separately classify foreground and background at each pixel are established. The design parameters include: the choice of kernel function k(•,•); whether the C-1SVM will train based on batch, online or modified online learning, or some combination; the size and shape of neighbourhoods about each pixel upon which each of the C-1SVM; the score function to be used, and the margin γ. Optionally, the initialization step also includes a choice of whether to classify based on the entire neighbourhood, or only subgroups within the neighbourhood in which case maxpooling and special decay (discussed below) would be used to classify each pixel according to a train-relabel loop.

Step 2: Obtaining an image or video stream for processing. The present method operates either on a single digital image or a video stream of digital images. A single image may be referred to as I^{o}, while a series of frames t in a video stream may be referred to as I^{t}.

Step 3: obtain initial background sample set (BSS) and initial foreground sample set (FSS). The sample sets of known background and foreground may be provided by user instructions (e.g. swiping a cursor over the image, identifying particular colours, etc.) in a supervised method, or through an automated unsupervised learning method. In the video stream, at each a given pixel in time/frame t, the sample sets of BSS and FSS are referred to jointly as the label L^{t}(p).

Step 4: Training of the C-1SVM occurs as follows. For each pixel, train the background-1SVM (B-1SVM) using the BSS and train the foreground-1SVM (F-1SVM) using the FSS.

Step 5: Classification of each pixel is performed independently by each 1SVM. The classification routine may be run on the entire neighbourhood. Or, by max pooling over other specified subgroups within the neighbourhood, as discussed below.

Step 6: Relabeling of the BSS and FSS occurs on a pixel-wise basis if the C-1SVM agrees as to the classification of the pixel as foreground or background. Otherwise, it is not relabelled. The steps 4 through 6 are repeated in a Train-Relabel loop until no new pixels are labelled. Four categories of pixels result: those labelled foreground by both classifiers, those labelled background by both classifiers, those labelled background by the F-1SVM and foreground by the B-1SVM, and those labelled foreground by the F-1SVM and background by the B-1SVM. This is a sufficient output of the segmentation method, but additional steps are also possible.

Step 7: optionally, a bianarization set further segments the non-binary output of Step 6 by forcing the unlabeled pixels into foreground or background according to some coherence rule. A global optimizing function (discussed below), has been shown to be useful in this regard.

Step 8: optionally, a smooth/erode function may be used to further prepare the output of Step 6 for insertion back into the algorithm at Step 4 as a proxy to additional supervised user labelling. Using the global optimizer to smooth the data and/or eroding the boundary by fixed number of pixels prepares new BSS and FSS data for the Train-Relabel loop in the following frame.

Step 9: (not shown) Nothing prohibits additional user relabeling of the BSS and FSS either in respect of a given frame, or prior to segmentation of a future frame.

### BRIEF DESCRIPTION OF THE DRAWINGS

FIG. 1 is a series of images showing the initialization of the segmentation method of the present invention on input frame 0 of the “walk” sequence in Y.-Y. Chuang, A. Agarwala, B. Curless, D. H. Salesin, and R. Szeliski, Video matting of complex scenes, Siggraph, 2002, pages 243-248 [Chuang 11] (images (a) through (f), followed by the segmentation steps at input frame 1 (images (g) through (i)) and input frame 99 (images (j) through (l).

FIG. 2 are Venn diagrams representing how prior methods of binary SVM (diagram (a)) differ from the method of the present invention in using dual C-1SVMs (diagram (b)).

FIG. 3 is a graphical depiction of the neighbourhood system used for 1SVM training on a 9×9 pixel local neighbourhood (Ωₚ) of the pixel shown.

FIG. 4 is a graphical depiction of the neighbourhood system used for 1SVM training on a 21×21 local neighbourhood (Ωₚ) of the pixel shown, using nine adjacent 7×7 pixel subgroups (\hat{Ω}ₚ) in a fully adjacent square formation.

FIG. 5 is a graphical depiction of the neighbourhood system used for 1SVM training on a 33×33 local neighbourhood (Ωₚ) of the pixel shown, using twenty-five non-adjacent 5×5 pixel subgroups (\hat{Ω}ₚ) which are in a regular square formation, but with 2-pixel wide strips separating 5×5 pixel subgroups (\hat{Ω}ₚ).

FIGS. 6(a), (b) and (c) show foreground assignment (in black) by the foreground-1SVM for image frame 0 from the sequence used in FIG. 1, after 1 iteration, 2 iterations, and convergence, respectively; while FIGS. 6(d), (e) and (f) show background assignment (in black) for the same image, and respective number of iterations; in each case using the grid initiation groupings and subgroupings of FIG. 5.

FIG. 7 shows results on testbed video input sequences referred to as (from top to bottom) “talk”, “jug”, “hand”, and “car”.

FIGS. 8(a) and 8(b) compare the segmentation accuracy of a preferred embodiment of the method of the present invention for two sequences, where a ground truth segmentation is available for every 5 or 10 frames.

FIG. 9 is a series of segmentation frames showing that one implementation of the C-1SVM segmentation method auto-corrects for the background bias shown for the final segmentation of the first input frame (images (a), (b) and (c)) over 10 frames following the initial frame (see examples in second row of images) without any user intervention.

FIG. 10 shows comparisons of preferred embodiments of present invention to existing prior art methods for the segmentation of the “jug” in the “jug” sequence, where: (a) is the input frame; (b) is the result using the segmentation method in [Zhong 1]; (c) is the result using the segmentation method in L. Cheng and M. Gong, Realtime background subtraction from dynamic scenes, ICCV, 2009 [Cheng 12]; (d) is the pure background training frame; (e) is the segmentation result of the present invention using (d) but without any user labelling; and (f) is the segmentation result of the present invention using user labelling.

FIG. 11 is a flow chart for a generalized video segmentation method according to the present application.

### DETAILED DESCRIPTION OF THE INVENTION

Certain implementations of the present invention will now be described in greater detail with reference to the accompanying drawings.

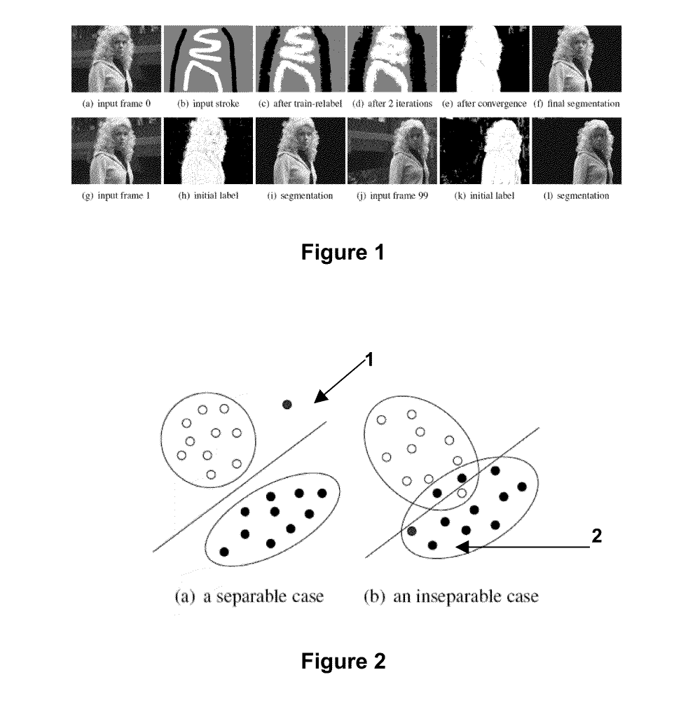

FIG. 1 shows how a preferred embodiment of the present invention implements foreground segmentation of the “walk” sequence from [Chuang 11], which is challenging due to fuzzy object boundary and camera motion. The user is only required to label the first frame (a) using strokes (b). Local classifiers are trained at each pixel location and then used to relabel the center pixel (c). Repeating training and relabeling leads to convergence (d-e), even though ambiguous (grey) areas still exist. Final segmentation is obtained using graph cuts (f). When the new frames (g & j) arrive, they are first labeled (h & k) using the classifiers trained by previous frames, before the same train-relabel procedure is used to produce the segmentation results (i) & (l). Note that the proposed algorithm is able to extract the details of the hair without resorting to matting techniques

FIG. 2 is a graphical representation of how prior methods of binary SVM differ from the method of the present invention in using dual C-1SVMs. The boundaries 3 and 5 represent the results of the foreground C-1 SVMs; the boundaries 4 and 6 represent the results of the background C-1SVMs; and the lines 7 and 8 represent binary SVM with above the line foreground and below the line background. White circles and black dots represent the foreground and background training instances, respectively, while dots 1 and 2 each denote an example unlabelled pixel being labelled using the method. In scenario (a), binary SVM classifies the test example 1 as foreground, whereas the C-1SVMs labels it as unknown, since neither of the 1SVMs accepts it as “inlier”. In the second case (b), binary SVM cannot confidently classify the test example since the margin is too small, whereas C-1SVMs is able to correctly label it as background.

The method of foreground segmentation proposed foregoing the classification of the problem as a binary matter; and instead creates two competing classifiers which operate independently. Where the competing classifiers disagree, the pixels are labelled unknown, and ultimately resolved through a final step globalized costing function. Improved performance is predicted for two reasons:

First, foreground and background may not be well separable in the color feature space. For example, the black sweater and the dark background shown in FIG. 1(a) share a similar appearance. As a result, it is not proper to deal with this scenario by means of training a global binary SVM and use it to classify the entire image. Furthermore, trying to train local binary SVMs at each pixel location is problematic as well since in most cases merely one of the two (fore/background) types of observations is locally available.

Second, even in areas that both fore/background examples are available, modeling the two sets separately using the C-1SVMs gives us two hyperplanes that enclose the training examples more tightly. As illustrated in FIG. 2, this helps toward better detecting and handling of ambiguous cases.

In the proposed method, the training can be based either on batch learning or online learning. Training a SVM using a large set of examples is a classical batch learning problem, the solution of which can be found through minimizing a quadratic objective function. Those of skill in the art will appreciate that similar or even better generalization performance can be achieved using online learning with a much less computational cost, by showing all examples repetitively to an online learner, when comparing to that of batch learning. A less noticed but distinct advantage of online learning is that it produces a partially trained model immediately, which is then gradually refined toward the final solution. However, either option may be practised within the scope of the method disclosed in this application.

In one example, the online learner of a preferred embodiment of the foreground segmentation method proceeds as follows: Let fₜ(•) be a score function of examples at time t, and let k(•,•) be a kernel function. Now, denote αₜ a non-negative weight of example of time t, and clamp(•,A,B), an identical function of the first argument bounded from both sides by A and B. When a new example, xₜ arrives, the score function becomes:

$${f}_{t} ( {x}_{t} ) = {\sum }_{i = 1}^{t - 1} {α}_{i} k ( {x}_{i} , {x}_{t} ) \qquad ( 1 )$$

In this example, the update rule for the weights is:

$${α}_{t} = clamp ( \frac{γ - ( 1 - τ ) {f}_{t} ( {x}_{t} )}{k ( {x}_{t} , {x}_{t} )} , 0 , ( 1 - τ ) C ) , \\ {α}_{i} ← ( 1 - τ ) {α}_{i} , \\ ∀ i = 1 , … , t - 1 \qquad ( 2 )$$

Where γ:=1 is the margin, τε(0,1) the decay parameter, and C>0 the cut-off value.

Directly applying Eq. (2) adds multiple support vectors to the model; all would come from the same sample and would have different weights. Also, as shown in Eq. (2), once a support vector (xₜ,αₜ) is added to the applicable 1SVM, over time its weight αₜ is only affected by the decay rate (1−τ). Hence, to ensure the support vectors converge to their proper weights, the decay parameter should be careful adjusted using e.g. cross validation results.

In a modified online learning example, and to avoid the complexity of monitoring/performing cross validation of results, the C-1SVM segmentation method may not rely on the decay at all, instead it may execute an explicitly reweighting scheme: If a training example xₜ arrives and it turns out identical to an existing support vector (xₜ,αₜ) inside the model, this support vector is first taken out when computing the score function, it is then included with its newly obtained weight, α′ₜ to substitute for the original weight αₜ. To summarize

$$\begin{matrix}{f}_{t} ( {x}_{t} ) = {\sum }_{i = 1}^{t - 1} {α}_{i} χ ( {x}_{i} \neq {x}_{t} ) k ( {x}_{i} , {x}_{t} ) , & ( 3 ) \\ {α}_{t} ← {α}_{t}^{′} = clamp ( \frac{γ - {f}_{t} ( {x}_{t} )}{k ( {x}_{t} , {x}_{t} )} , 0 , ( 1 - τ ) C ) , & ( 4 )\end{matrix}$$

where χ(•) is an indicator function: χ(true)=1 and χ(false)=0.

Intuitively, this modified online learning method resets the weight component of a particular support vector (xₜ,αₜ), based on how well the separating hyperplane defined by the remaining support vectors is able to classify example xₜ. This reweighting process can either increase or decrease αₜ and hence an implementation of the C-1 SVM using modified online learning does not rely on decay as do some prior art methods. With fewer operations, this leads to a method with shorter training time (i.e. fewer computations).

### Maxpooling of Subgroups

Training 1SVMs with large scale examples is known to be computationally expensive, which becomes a serious issue in a real-time processing scenario. In addition to online learning, in one example, the present segmentation method proposes “max-pooling” of subgroups, as follows: the whole example set ψ is divided into N non-intersecting groups ψ_{iε}(0≦i<N) and a 1SVM is trained on each group. Then the original 1SVM score function is approximated by the maximum operation of these 1 SVM score functions from subgroups. That is:

f(x)=max_{0≦i<N}f^{ψ}^{ᵢ}(x), (5)

where f^{ψ}^{ᵢ}(•) is the score function trained using examples in subgroup ψᵢ.

Different options are proposed for dividing examples into subgroups, and thereby exploit the spatial coherence of images so that the 1SVM trained on each subgroup models local appearance density.

In addition to the idea of using competing, separately initialized and trained 1SVM classifiers for the foreground segmentation, another improvement exists in the train-relabel procedure between video frames (i.e. in time). Two competing 1SVMs, [symbol] ₚ for foreground and [symbol] ₚ for background, are trained locally for each pixel p using pixels with known labels within the local window/neighbourhood Ωₚ. Once trained, [symbol] ₚ and [symbol] ₚ are used to jointly label p as either foreground, background, or unknown. Since the knowledge learned from neighbouring pixels in the neighbourhood group Ωₚ is used for labelling pixel p, the above procedure effectively propagates known foreground and background information to its neighbourhood. As a result, and as shown in FIGS. 1(a), (b), (c), (d), (e) and (f), the algorithm can segment the whole image based on only a few initial strokes.

For inter frame training, a similar train-relabel procedure for iteratively expanding propagating foreground and background information in a single frame is used for handling interframe/temporal changes as well. When a new frame t+1 arrives, the label L^{t+1}(p) is initialized automatically using the existing [symbol] ₚ and [symbol] ₚ. The initial labels, together with newly observed colors, are then used to conduct the train-relabel process. Since [symbol] ₚ and [symbol] ₚ are trained using all pixels within Ωₚ of frame t, if any of these pixels moves to within the radius of Ωₚ of pixel p, [symbol] ₚ and [symbol] ₚ can attempt to classify it. Consequently, the algorithm can handle arbitrary foreground and background movement without a priori motion information, as long as the amount of movement is less than the radius of the neighbourhood grouping Ω.

Under ideal situations, where the appearance distributions of foreground and background pixels are locally separable, the above baseline procedure is sufficient. However, the two distributions may intersect due to fuzzy object boundary, motion blur, or low color contrast. To address these cases, global optimization is applied to enforce the smoothness of the solution. In addition, when moving to a new frame, decaying is applied to existing support vectors for better adapting to temporal changes. The details for the above steps are discussed in the each of the following subsections.

### Train Local C-1SVMs at Each Pixel Location

When training the two competing classifiers, [symbol] ₚ and [symbol] ₚ at each pixel p, the size of the local/frame window Ωₚ is an important parameter. It needs to be small enough so that the local foreground/background appearance distributions are separable, but also large enough for effective propagation of label information and for covering foreground/background motions.

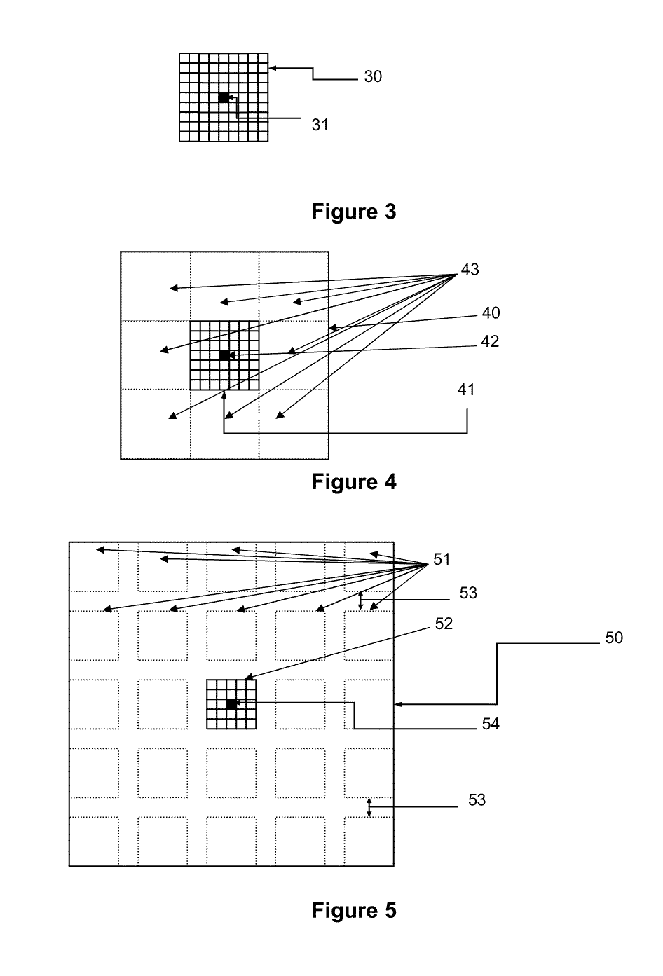

FIGS. 3, FIG. 4 and FIG. 5 provide different configurations of neighbourhood Ωₚ for use within this method. Neighbourhood Ωₚ is a design feature adjustable by those practicing this method, and the invention is not limited to particular of these configurations which are examples only. Different neighbourhood settings that can be used for 1SVM training. For example, in FIG. 3, for the center pixel 31, all pixels within the local 9×9 neighborhood 30 are used for training. In FIG. 4, a larger 21×21 neighbourhood 40 is divided into nine 7×7 subgroups, where only pixels inside the center subgroup 41 are used for training at centre pixel 42, and the centres of the other 8 subgroups 43 trained in a similar fashion may be used in the max pooling operation. In FIG. 5, an even larger 33×33 neighbourhood 50 is divided into 25 subgroups 51 (only some labelled), with each subgroup having 25 pixels and a 2-pixel wide gap 53 between adjacent subgroups 51. Center point 54 of centre subgroup 52 is trained in the image show, but all pixels sufficiently within the image are trained in a corresponding manner. The optimal setting depends on the applications. Settings in FIGS. 3 and 4 are expected to work better for videos that contains high frequency details since all pixels are used for training, whereas setting in FIG. 5 is preferred for high resolution videos as it covers a larger neighbourhood.

In all images processed in the Figures, the method of foreground segmentation uses Equation 3 and Equation 4, and the frame window, Ωₚ, as been set to 33×33 pixels, large enough to deal with motions of up to 16 pixels between adjacent frames. A skilled user could implement the present invention using larger windows, at a larger computational cost, in order to address greater relative motion of foreground within the video stream. Since using a 33×33 window means 1089 examples are used for training each 1SVM, and training is performed for 1SVMs at all pixel locations: using the entire frame window is not affordable for real-time processing. To reduce the training cost, the techniques noted above for online learning with reweighting and batch pooling of results are applied here.

First, using the max-pooling method discussed above, the 1089 examples inside Ωₚ are divided into twenty-five subgroups. FIG. 3 depicts the neighborhood system used for 1SVM training of the segmentation method. For the center pixel p 54, the pixels within the local 33×33 window is divided into 25 subgroups, with each subgroup having twenty-five pixels and a 2-pixel wide gap between adjacent subgroups \hat{Ω}ₚ.

As shown in the example of FIG. 5, to further take advantage of the spatial coherence among neighbouring pixels, the method proposes leaving a 2-pixel wide gap 53 between adjacent subgroups 51. For a given centre pixel 54, pixels inside the gap are not used to train the foreground and background classifiers at pixel p, [symbol] ₚ and [symbol] ₚ, but for the training of other pixels within the subgroup radius, they are used. Since these local 1SVMs are trained at all pixel locations simultaneously, after splitting the examples into subgroups, the C-1SVMs at each pixel location only need to be trained using pixels in the center subgroup at that location. The training for the remaining twenty-four subgroups will occur at their corresponding center pixel locations.

This strategy permits the method of the present invention to reduce the computational costs of training from using 1089 examples to using just twenty-five examples. For the sake of clarity, the symbols [symbol] ₚ and [symbol] ₚ are reserved for the two C-1SVMs obtained through training with all examples in Ωₚ, and the symbols [symbol] ₚ and [symbol] ₚ to denote the C-1SVMs trained using pixels in the center subgroup ̂ₚ.

Moreover, as suggested above, online learning may be employed to provide an on-demand feedback during the train-relabel process. If a user is unsatisfied with the initialization, or future segmentation, the user may force additional labelling onto the frame by further supervision of the foreground and background sets. As shown in Algorithm 1, instead of repetitively showing examples in Ωₚ to [symbol] ₚ and [symbol] ₚ and waiting for the training to converge, another implementation of the foreground segmentation method only shows these examples once in each train step. The partially trained 1SVMs are then immediately used to perform relabeling. This enables a faster propagation of labelling information through neighbourhoods. Hence, empirically, it allows a faster convergence of the train-relabel process. For example, starting from the input user stokes shown in FIG. 1(b), it takes this preferred embodiment of the method about 40 iterations to propagates labelling information to the whole image and generate segmentation for the first frame. Afterward, it only takes 2-3 iterations to update the 1SVMs and segment a new frame.

### Relabel Each Pixel Using Learned C1SVMs

Once [symbol] ₚ and [symbol] ₚ are trained, they are used jointly to classify pixel p. That is, pixel p is labelled as foreground or background only if the two competing classifiers output consistent predictions. Otherwise pixel p is labeled as unknown.

As shown in Algorithm 2, the relabeling module starts by, computing the scores of observation I(p) based on Equation (3) with both [symbol] ₚ and [symbol] ₚ. As explained above, these two quantities are approximated by the scores of [symbol] ₚ and [symbol] ₚ from a set of nearby subgroups and by taking the maximum. To allow examples closer to p have higher influence than those further away, the implementation may optionally defined a spatial decay parameter τ_{spacial}, to attenuate the weight of more distant pixels on the pixel being labelled.

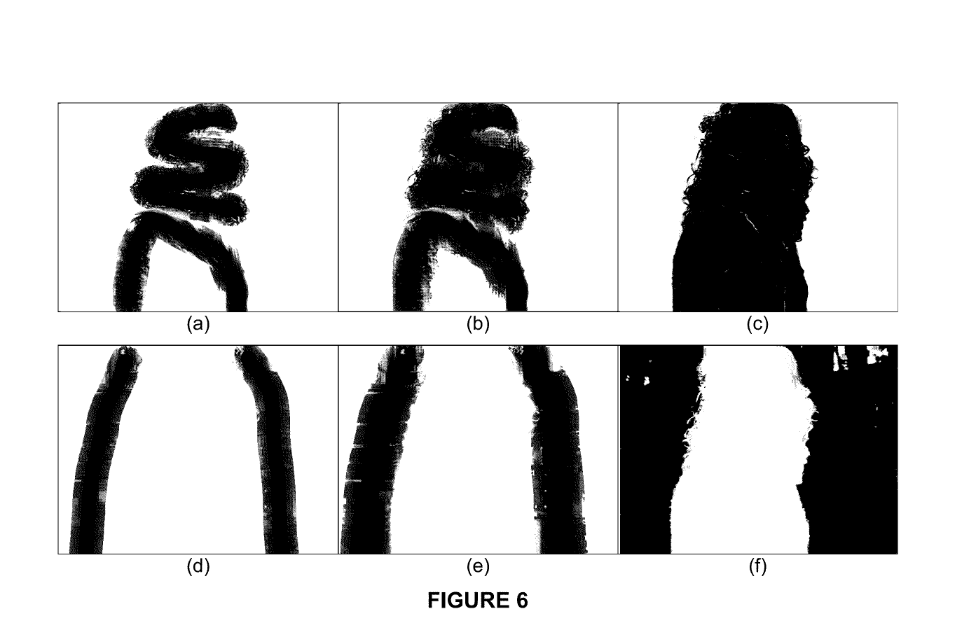

FIG. 6 demonstrates this process on the “walk” sequence after different numbers of iterations. In FIG. 6(a) (1 iteration), FIG. 6(b) (2 iterations) and FIG. 6(c) (convergence of the foreground-1SVM), the foreground-1 SVM labels pixels white if the classifier would assigned high penalty for association of such pixel with foreground and black if the classifier would assign low penalty for association of such pixel with foreground. Similarly, in FIG. 6(d) (1 iteration), FIG. 6(e) (2 iterations) and FIG. 6(f) (convergence of the background-1SVM), the background-1SVM labels pixels white if the classifier would assigned high penalty for association of such pixel with background and black if the classifier would assign low penalty for association of such pixel with background. Pixels which are white in both FIG. 6(c) and FIG. 6(f) are not labelled by either classifier. Pixels which are labelled black in both FIG. 6(c) and FIG. 6(f) are boundary pixels which both classifiers are trying to claim, i.e. pixels which would be assigned low penalty for association with either foreground by the foreground-1SVM or background by the background-1SVM. Thus, according to the implementation of the C-1 SVM, p is thus classified as foreground (or background), if and only if. the loss of [symbol] ₚ (or [symbol] ₚ) is low and the loss of [symbol] ₚ (or [symbol] ₚ) is high. This dual thresholding strategy facilitates the detection of ambiguities, which is used to prevent incorrect labeling information from being propagated. Please note, where these loss values are used to produce the label maps of FIGS. 1(b), (c), (d), (e), (h) and (k), foreground is shown in white, background in black and unknown in grey.

One implementation of the C-1SVM, therefore, proposes Algorithm 1 to train C-1SVMs using frame I^{t} and label L^{t}, and Algorithm 2 for relabeling input frame I^{t} using the C-1SVMs.

Algorithm 1:

for each pixel p do

for each pixel q in \hat{Ω}ₚ do

| | |
|---|---|
| if | L^{t}(q) equals foreground then |
| | Use L^{t}(q) to train Fₚ based on either |
| | Equations (1) & (2) or Equations (3) & (4); |
| else if | L^{t}(q) equals background then |
| | Use L^{t}(q) to train Bₚ based on either |
| | Equations (1) & (2) or Equations (3) & (4); |
| end if | |

end for

end for

Algorithm 2

Require: Threshold parametersT_{F}^{low} , T_{F}^{high},T_{B}^{low}, T_{B}^{high}
for each pixel p do

| Initialize approximate scores f_{F}(p) and f_{B}(p) to 0; | |
|---|---|
| for | each subgroup \hat{Ω}_{q} in Ωₚ do |
| | Set special attenuation ω = (1 − τ_{spacial})^{\|\|p-q\|\|}; |
| | Set foreground score |
| | f_{F}(p) = max (f_{F}(p), ω [symbol] (I^{t}(p))); |
| | Set background score |
| | f_{B}(p) = max (f_{B}(p), ω [symbol] (I^{t}(p))); |
| end for | |
| Set margin γ = (1, or some other user determined amount) | |
| Set foreground loss [symbol] (p) = max (0,γ − f_{F}(p)); | |
| Set background loss [symbol] (p) = max (0,γ − f_{B}(p)); | |
| if | (lF(p) < T_{F}^{low}) && (l_{B}(p) > T_{B}^{low}) then |
| | Set L^{t}(p) to foreground; |
| else if | (lF (p) > T_{F}^{High}) && (l_{B}(p) < T_{B}^{low}) then |
| | Set L^{t}(p) to background; |
| else | |
| | Set L^{t}(p) to unknown; |
| end if | |

end for

To the extent that the above algorithm performs SVM training which may be implemented using different variations, which may have other steps, it should be considered within the scope of the invention if the overall approach is to use two completing 1-class support vector machines to compete in the labelling of each pixel. Furthermore, the use of subgroupings \hat{Ω}_{q} which are mere non-intersecting subsets of Ωₚ, is a preferred implementiaton of the C-1SVM method, but not a requirement. Indeed, the use of subgroupings \hat{Ω}_{q} which are mere subsets of Ωₚ is considered to be a new approach in respect of all SVMs.

### Bianarization: Force or Apply Global Optimization

While explicitly labelling ambiguous pixels as unknown helps to prevent error propagation during the train-relabel process, decisions still need to be made for these pixels in the final segmentation. If desired, the segmentation following convergence of Algorithm 2 may be bianarized in a simple fashion by forcing label coherence among neighbouring pixels. Alternatively, global optimization may be applied to the results of segmentation after convergence of Algorithm 2, to obtain a more accurate binarization. In addition, the pixel-wise prediction result based on previous sections often tends to be noisy (see FIG. 1(e)). To obtain a clean binary segmentation, the final step of one implementation of the method is to compute the global optimal solution G^{t} for a Markov random field based energy function, which consists of a data term and a contrast term. The data term, i.e. the costs of assigning pixel p to foreground and background, is set using [symbol] (p) and [symbol] (p) directly. The contrast term is that used in [Criminisi 8] and [Sun 2], which adaptively penalizes segmentation boundaries based on local color differences.

It is known that the global optimizing function G^{t} can be calculated efficiently using graph cuts. In one example of the present foreground segmentation technique, a version of the push-relabel algorithm is implemented to compute the min cuts, wherein the number of push-relabel steps is limited to 20. This was sufficient for the examples shown in the Figures, although a skilled practitioner of the present invention may chose a greater or lesser number of iterations based on computational constraints or other considerations.

Dealing with Incoming Frames

When a new frame t+1 arrives, the following preparation procedures are performed before the train-relabel procedure:

First, the classifier is informed of the results of the bianarization, after optional erosion of the boundary pixels. If the global optimizing function G^{t} was used to bianarize (coined to mean render binary) the output of Algorithm 2, then this final output is used as the sample space to train the C-1SVMs at frame t+1. Since the ambiguous areas are labeled in G^{t} using smoothness constraints, using it to train [symbol] and [symbol] helps to resolve ambiguities in future frames. Nevertheless, pixels along the boundary between the foreground and background often have mixed colors. Using these pixels for training may introduce bad examples to [symbol] and [symbol] , which in turn may cause incorrect labeling. An optional step of the method, therefore, circumvents this problem by applying morphological erode to both the foreground and the background regions in G^{t} to remove ambiguities. In the case shown, 2 pixels erosion is found to be sufficient.

Second, to allow the C-1SVMs to better adapt to the temporal changes of fore/background appearance distributions, a temporal decay is applied: after L^{t+1} is predicted, the weights of existing support vectors in [symbol] and [symbol] are downweighted by a factor (1−τₜₑₘₚₒᵣₐₗ).

### Experiments

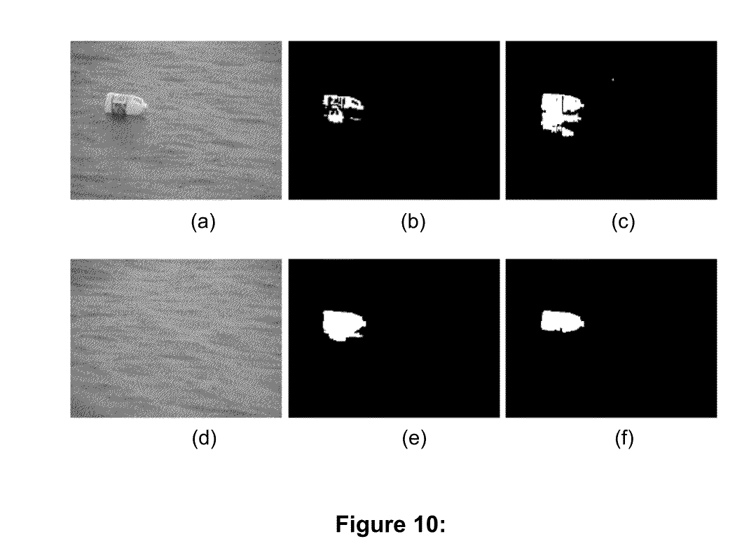

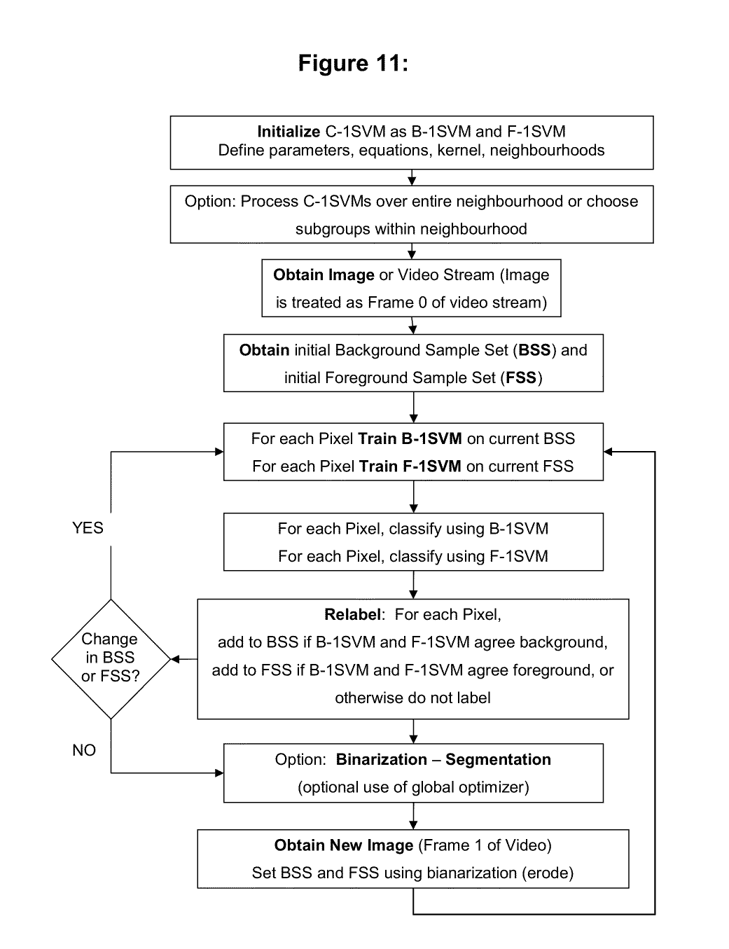

In the examples shown, the C-1SVM method was implemented on a GPU using DirectCompute, which is proposed by Microsoft as an alternative to CUDA and is included in the Direct3D11 API. For VGA-sized videos, so as to exploit the inherit parallel structure of the method. In each of the examples shown in the FIGS. 1, 6, 7, 8, 9 and 10, the current implementation runs at 14 FPS on a Lenovo ThinkStation S20 with nVidia GeForce GTX 480 GPU. Except for the cases presented in FIG. 10 (discussed below) will, the same set of parameter values are used in the other examples, namely:

C=0.5,τₜₑₘₚₒᵣₐₗ=0.25,τ_{spacial}=0.05, [symbol] =0.1,

[symbol]

=0.3, [symbol] = [symbol] =0.4

Notice that the background labelling requirements (l [symbol] < [symbol] and l [symbol] > [symbol] ) are intentionally looser than those for foreground objects. Leveraged with a relatively high temporal decay τₜₑₘₚₒᵣₐₗ, these parameter choices introduce a tendency of accepting unseen examples as background, which allows proper handling of background changes. Furthermore, the kernel function k(•,•) is computed as a Gaussian kernel with σ=10. Where Gaussian kernels are used the parameters are tuned through cross validation. The lower the value of [symbol] , the more easily a pixel is classified as foreground. Similarly, the lower the value of [symbol] the more easily a pixel is classified as background. The method is not limited to the parameters used in these tests, but may be varied according to the art and the declosures herein. Although the Gaussian kernel is used here, any kernel function known to be suitable for support vector machines could be used, including: homogeneous polynomial, unhomogeneous polynomial, Guassian radial basis function, hyperbolic tangent.

Results on Testbed Videos:

As displayed in FIGS. 1, 6, 7, 8, 9 and 10, the method of the present invention has been tested over a variety of video scenarios used in the prior art. The segmentation results are visually satisfactory and are comparable to the state-of-the-art approaches that are designed specifically for video conferencing, background subtraction, or for handling a freely moving camera.

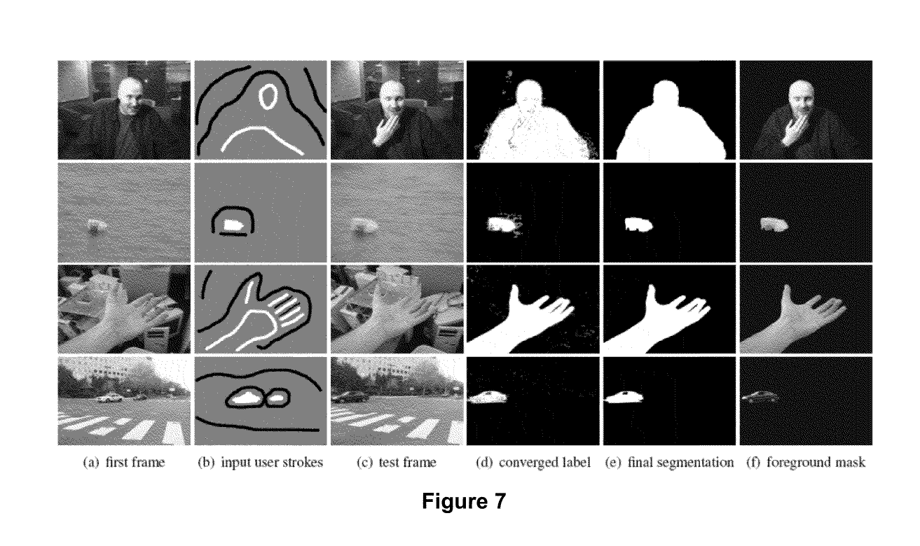

FIG. 7 shows the results of the proposed algorithm on testbed sequences referred as (from top to bottom) “talk”, “jug”, “hand”, and “car”. The results clearly demonstrate the capacity of the method of the present invention to deal with different challenges, such as background changes (in “talk”), repetitive background motion (in “jug”), camera motion (in “hand” & “car”), strong motion blur (caused by camera zooming in “jug”), non-rigid foreground deformations (in “talk” & “hand”), topology changes (holes in “hand” & “car”), and low fore/background color contrast (in “talk” & “car”).

Quantitative Evaluation Using Ground Truth:

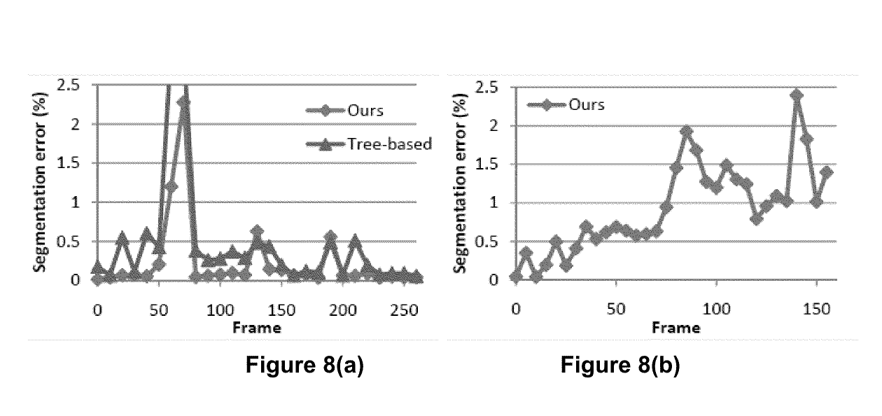

For a fair comparison with previous approaches which used multiple annotated images for training, the C-1SVM method disclosed herein was trained using both the first frame and one more selected frame where the initially occluded foreground portion is visible. FIG. 8 compares the segmentation accuracy for two such sequences, where a ground truth segmentation is available for every 5 or 10 frames. In FIG. 8(a), the performance of the method of the present C-1SVM method (light grey line with diamonds) is compared favourably with the tree based approach (dark grey with triangles) taken from [Yin 9], and the “JM” sequence used therein. In FIG. 8(b), the chart shows the segmentation percentage error on a frame by frame basis for the “IU” sequence taken from [Kolmogorov 7] and [Yin 9]. In each case, the percentage segmentation error for the C-1SVM method using the max pooling of 33×33 neighbourhood of twenty-five 5×5 subgroups spaced 2 pixels apart, remains below 2.5% over each sequence. FIG. 8 shows the quantitative evaluations which demonstrate that the median segmentation errors are 0.07% and 0.88% for the two sequences, respectively. In comparison, [Yin 9] reports higher median errors of 0.27% and 2.56% for the same sequences.

Ability to Recover from Incorrect Predictions:

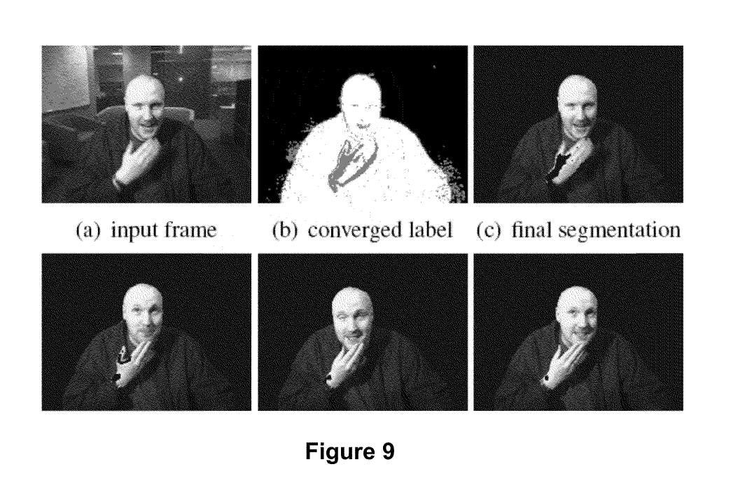

While the aforementioned tendency of accepting unseen examples as background helps to correctly handle background changes, such as the background person in “talk” and new background scene in “walk”, it occasionally introduces errors if locally unseen foreground appearances are presented. Nevertheless, the redundancy of using two competing 1SVMs helps limit the effect incorrect labels have on the training of foreground 1SVMs, which gradually recognize the novel foreground colors. FIG. 9 is a series of segmentation frames showing that a preferred embodiment of the method of the present invention auto-corrects for the background bias shown for the final segmentation of the first input frame (images (a), (b) and (c)) over 10 frames following the initial frame (see examples in second row of images) without any user intervention. When the hand first shows up in FIG. 9(a), both local foreground and background 1SVMs classify pixels with unseen colors as outliers, resulting in unknown (grey) labels in FIG. 9(b). In the final segmentation on the input frame shown in FIG. 9(c), the initialization has labelled these pixels incorrectly due to the bias toward background. However, the algorithm corrects the mistakes in 10 frames without any user intervention, as shown in three example images in the 2nd row of FIG. 9. As a result, the mistakes are corrected by the present invention after a few consecutive frames without any user intervention.

Ability to Work in Background Subtraction Scenario:

With a different set of threshold settings ( [symbol] =∞ and [symbol] =0.2), the algorithm can also be initialized by one or a few pure background image(s) instead of any stroke. Under this setup, only the local background 1SVMs are trained initially. As new frames are processed, outliers to the background 1SVMs are classified as foreground, which are then utilized to initiate the training of local foreground 1SVMs. Meanwhile inliers are used to update the background 1SVMs, allowing the algorithm to adapt to dynamic changes and background motion. As displayed in FIG. 10, the additional foreground 1SVMs help the method of the present invention to remember the detected foreground appearance, and as a result, lead to better performance than such of the previous work which only used local background models. FIG. 10(a) is the input frame, and FIG. 10(d) is the pure background training frame. FIG. 10(b), the result using the segmentation method in [Zhong 1], and FIG. 10(c), the result using the segmentation method in [Cheng 12], do not perform as well as either FIG. 10(e), the segmentation result of the present invention using the pure background initialization of FIG. 10(d) without any user labelling, or FIG. 10(f), the present C-1SVM method user labelling. The results of the algorithms in FIGS. 10(b) and (c) are reported in their respective papers.

### 4. CONCLUSIONS

The C-1SVM method is easy to implement, simple to use, and capable of handling a variety of difficult scenarios, such as dynamic background, camera motion, topology changes, and fuzzy object boundaries. Experiments on standard testbed videos demonstrate that the implementation of the C-1SVM method used for testing possesses comparable or superior performance comparing to the other state-of-the-art approaches referred to herein.

It would be readily apparent to a person of skill in the art that the above procedures may be configured on other computing platforms in known ways, to achieve different results based on the processing power of such computing systems.

The foregoing embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. A computer implemented method for segmenting a digital image into foreground and background comprising the steps of:
(a) Initializing design parameters for a background 1-class support vector machine (B-1SVM) and for a foreground 1-class support vector machine (F-1SVM) as computer implemented functions within a computer system;
(b) Inputting the digital image to the computer system;
(c) Inputting a background sample set of known background pixels in the image and a foreground sample set of known foreground pixels in the image, to the computer system to define an current label of the image;
(d) Until no further changes occur in the current label of the image, perform the following computer implemented steps of:
(i) Training a B-1SVM based on the design parameters at each pixel using pixels labelled as background within the current label of the image, and training a F-1SVM based on the design parameters at each pixel using pixels labelled as foreground within the current label of the image;
(ii) Classifying each pixel using the B-1SVM and the F-1SVM to obtain a competing classification for each pixel; and
(iii) Relabeling the current label of the image to identify the pixels which the competing classification agrees to be background and to identify the pixels which the competing classification agrees to be foreground.

2. The computer implemented method of claim 1 further comprising the step of:
(e) Applying a global optimizing function to relabel as either foreground or background within the current label of the image, pixels in the image which have not yet been labelled as foreground or background by the B-1SVM and the F-1SVM.

3. The computer implemented method of claim 1 wherein the background sample set is obtained through unsupervised means.

4. The computer implemented method of claim 1 wherein the background sample set is obtained through supervised means.

5. The computer implemented method of claim 1 wherein the foreground sample set is obtained through unsupervised means.

6. The computer implemented method of claim 1 wherein the foreground sample set is obtained through supervised means.

7. The computer implemented method of claim 1 wherein the design parameters include a kernel function k(•,•) from the group of kernel functions consisting of: homogeneous polynomial basis function, unhomogeneous polynomial basis function, Guassian radial basis function, and hyperbolic tangent basis function.

8. The computer implemented method of claim 7 wherein the kernel function k(•,•) is a Guassian radial basis function.

9. The computer implemented method of claim 1 wherein the design parameters include a neighbourhood, and the training step and classifying step at each pixel occur over the entire neighbourhood about such pixel.

10. The computer implemented method of claim 1 wherein the design parameters include a neighbourhood further divided into subgroups, the training step at each pixel uses only pixels in the subgroup centred on such pixel and the classifying step uses only centre pixels at the subgroups in the neighbourhood.

11. The computer implemented method of claim 10 wherein the neighbourhood about each pixel is 3n by 3n pixels centred on such pixel (n an odd integer greater than 1), and the subgroups are 9 non-intersecting n by n squares within the neighbourhood.

12. The computer implemented method of claim 10 wherein the neighbourhood about each pixel is a square of k times n plus (k−1) times g pixels on each side, where n is an odd integer greater than 1 being the width of each subgroup, k is an odd integer greater than 1 with k² being the number of subgroups, and g is the width in pixels of a gap between subgroups such that g times 2 plus 1 is not greater than n.

13. The computer implemented method of claim 10 wherein the neighbourhood about each pixel is 33 by 33 pixels centred on such pixel, the neighbourhood is further divided into twenty-five non-intersecting subgroups of 5 by 5 pixel squares with adjacent subgroups all separated by a 2 pixel wide gap.

14. The computer implemented method of claim 2 wherein the global optimizing function solves, for each pixel, a Markov random field based energy function having a data term determined by costs of assigning such pixel to foreground and background and a contrast term which adaptively penalizes segmentation boundaries based on local color differences.

15. The computer implemented method of claim 1 wherein the training step is performed by a learning method from the group of learning methods consisting of batch learning methods, online learning methods of modified online learning methods.

16. The computer implemented method of claim 15 wherein the modified online learning method is performed according to Equation (3) and Equation (4).

17. The computer implemented method of claim 10 wherein the training step is performed according to the following algorithm, for a centre subgroup \hat{Ω}ₚ within the neighbourhood of each pixel p, for the current label of the image L^{t}
```
for each pixel p do
  for each pixel q in \hat{Ω}ₚ do
    if L^{t}(q) equals foreground then
      Use L^{t}(q) to train \hat{F}ₚ based on Equations (3) & (4);
    else if L^{t}(q) equals background then
      Use L^{t}(q) to train \hat{B}ₚ based on Equation (3) & (4);
    end if
  end for
end for
```

18. The computer implemented method of claim 17 wherein the classifying step is performed according to the following algorithm, with design parameters [symbol] , [symbol] , [symbol] , [symbol] set, foreground score function at pixel p being f [symbol] (p), background score function at pixel p being f_{B}(p), and subgroups \hat{Ω}_{q} being the subgroups in neighbourhood Ωₚ of pixel p which do not intersect pixel p:
for each pixel p do

| Initialize approximate scores [symbol] (p) and [symbol] (p) to 0; | |
|---|---|
| for | each subgroup \hat{Ω}_{q} in Ωₚ do |
| | Set ω = (1 − τ_{spacial})^{\|\|p-q\|\|}; |
| | Set fF(p) = max (f_{F}(p), ω [symbol] (I^{t}(p))); |
| | Set fB(p) = max (f_{B}(p), ω [symbol] ^{q}(I^{t}(p))); |
| end for | |
| Set foreground loss l_{F}(p) = max (0,γ − [symbol] (p)); | |
| Set background loss l_{B}(p) = max (0,γ − [symbol] (p)); | |
| if | (l_{F}(p) < T_{F}^{low}) && (l_{B}(p) > T_{B}^{high}) then |
| | Set L^{t}(p) to foreground; |
| else if | (l_{F}(p) > T_{F}^{high}) && (l_{B}(p) < T_{B}^{low}) then |
| | Set L^{t}(p) to background; |
| else | |
| | Set L^{t}(p) to unknown; |
| end if | |

end for.

19. The computer implemented method of claim 18 wherein the following design parameters are set as margin γ=1, [symbol] =0.1, [symbol] =0.3, [symbol] = [symbol] =0.4, cut off value C=0.5, and spacial decay τ_{spacial}=0.05.

20. A computer implemented method for segmenting a video stream of digital images into foreground and background comprising the steps of:
(a) Initializing design parameters for a background 1-class support vector machine (B-1SVM) and for a foreground 1-class support vector machine (F-1SVM) as computer implemented functions within a computer system;
(b) Inputting the digital images of the video stream to the computer system;
(c) Inputting to the computer system a background sample set of known background pixels in a current image and a foreground sample set of known foreground pixels in such current image, to define a current label of the current image;
(d) Until no further changes occur in the current label of the current image, perform on pixels of the current image the train-relabel steps of:
(i) Training a B-1SVM based on the design parameters at each pixel within the current image using pixels labelled as background within the current label of the current image, and training a F-1SVM based on the design parameters at each pixel using pixels labelled as foreground within the current label of the current image;
(ii) Classifying each pixel using the B-1SVM and the F-1SVM to obtain a competing classification for each pixel; and
(iii) Relabeling the current label of the current image to identify the pixels which the competing classification agrees to be background and to identify the pixels which the competing classification agrees to be foreground;
(e) While images remain to be processed in the video stream, set the next image in the video stream as the current image and return to step (d).

21. The computer implemented method of claim 20 further comprising the step after step (d) and before step (e) of:
(d.1) Applying a global optimizing function to relabel as either foreground or background within the current label of the current image, pixels in the image which have not yet been labelled as foreground or background by the B-1SVM and the F-1SVM.

22. The computer implemented method of claim 21 further comprising the step after step (d.1):
(d.2) relabeling the current label for the current image to the output of the global optimizing function with morphological erosion on a boundary where pixels identified as foreground are otherwise adjacent to pixels identified as background.

23. The computer implemented method of claim 20 wherein the background sample set is obtained through unsupervised means.

24. The computer implemented method of claim 20 wherein the background sample set is obtained through supervised means.

25. The computer implemented method of claim 20 wherein the foreground sample set is obtained through unsupervised means.

26. The computer implemented method of claim 20 wherein the foreground sample set is obtained through supervised means.

27. The computer implemented method of claim 20 wherein the design parameters include a kernel function k(•,•) from the group of kernel functions consisting of: homogeneous polynomial basis function, unhomogeneous polynomial basis function, Guassian radial basis function, and hyperbolic tangent basis function.

28. The computer implemented method of claim 27 wherein the kernel function k(•,•) is a Guassian radial basis function.

29. The computer implemented method of claim 20 wherein the design parameters include a neighbourhood, and the training step and classifying step at each pixel occur over the entire neighbourhood about such pixel.

30. The computer implemented method of claim 20 wherein the design parameters include a neighbourhood further divided into subgroups, the training step at each pixel uses only pixels in the subgroup centred on such pixel and the classifying step uses only centre pixels at the subgroups in the neighbourhood.

31. The computer implemented method of claim 30 wherein the neighbourhood about each pixel is 33 by 33 pixels centred on such pixel, the neighbourhood is further divided into twenty-five non-intersecting subgroups of 5 by 5 pixel squares with adjacent subgroups all separated by a 2 pixel wide gap.

32. The computer implemented method of claim 21 wherein the global optimizing function solves, for each pixel, a Markov random field based energy function having a data term determined by costs of assigning such pixel to foreground and background and a contrast term which adaptively penalizes segmentation boundaries based on local color differences.

33. The computer implemented method of claim 20 wherein the training step is performed by a learning method from the group of learning methods consisting of batch learning methods, online learning methods of modified online learning methods.

34. The computer implemented method of claim 33 wherein the modified online learning method is performed according to Equation (3) and Equation (4).

35. The computer implemented method of claim 30 wherein the training step is performed according to the following algorithm, for a centre subgroup \hat{Ω}ₚ within the neighbourhood of each pixel p, for the current label of the image L^{t}
```
for each pixel p do
      for each pixel q in \hat{Ω}ₚ do
            if L^{t}(q) equals foreground then
                  Use L^{t}(q) to train \hat{F}ₚ based on Equations (3) & (4);
            else if L^{t}(q) equals background then
                  Use L^{t}(q) to train \hat{B}ₚ based on Equation (3) & (4);
            end if
      end for
end for
```

36. The computer implemented method of claim 35 wherein the classifying step is performed according to the following algorithm, with design parameters [symbol] , [symbol] , [symbol] , [symbol] set, foreground score function at pixel p being [symbol] (p), background score function at pixel p being f_{B}(p), and subgroups \hat{Ω}_{q} being the subgroups in neighbourhood Ωᵥ of pixel p which do not intersect pixel p:
```
for each pixel p do
      Initialize approximate scores f_{F}(p) and f_{B}(p) to 0;
      for each subgroup \hat{Ω}_{q} in Ωₚ do
            Set ω = (1 − τ_{spacial})^{||p-q||};
            Set f_{F}(p) = max (f_{F}(p), ωf_{F}^{\hat{Ω}q}(I^{t}(p)));
            Set f_{B}(p) = max (f_{B}(p), ωf_{B}^{\hat{Ω}q}(I^{t}(p)));
      end for
      Set foreground loss l_{F}(p) = max (0,γ − f_{F}(p));
      Set background loss l_{B}(p) = max (0,γ − f_{B}(p));
      if (l_{F}(p) < T_{F}^{low}) && (l_{B}(p) > T_{B}^{high}) then
            Set L^{t}(p) to foreground;
      else if (l_{F}(p) > T_{F}^{high}) && (l_{B}(p) < T_{B}^{low}) then
            Set L^{t}(p) to background;
      else
            Set L^{t}(p) to unknown;
      end if
end for.
```

37. The computer implemented method of claim 36 wherein the following design parameters are set as margin γ=1, [symbol] =0.1, [symbol] =0.3, [symbol] = [symbol] =0.4, cut off value C=0.5, and spacial decay τ_{spacial}=0.05.

38. A method for real-time segmentation of a foreground object from a video stream comprising the steps of:
(a) Inputting the video stream to a computer system;
(b) Applying computer implemented instructions on the computer system to establishing a background 1-class support vector machine (B-1SVM) and a foreground 1-class support vector machine (F-1 SVM) to analyse pixels in frames of the video stream;
(c) Obtaining user selected criteria on a location of the foreground object within one or more of the frames;
(d) Applying the background C-1SVM and the foreground C-1SVM to the video image initialized by the user selected criteria on the location of the foreground object;
(e) Applying computer implemented instructions to implement the following initialization algorithm on desired subgroups of pixels:
```
for each pixel p do
      for each pixel q in \hat{Ω}ₚ do
            if L^{t}(q) equals foreground then
                  Use L^{t}(q) to train \hat{F}ₚ based on Equations (3) & (4);
            else if L^{t}(q) equals background then
                  Use L^{t}(q) to train \hat{B}ₚ based on Equation (3) & (4);
            end if
      end for
end for
```
(f) applying computer implemented instructions for foreground, background and boundary segmentation using the following algorithm: Require: Threshold parameters: [symbol] , [symbol] , [symbol] , now [symbol]
```
for each pixel p do
      Initialize approximate scores f_{F}(p) and f_{B}(p) to 0;
      for each subgroup \hat{Ω}_{q} in Ωₚ do
            Set ω = (1 − τ_{spacial})^{||p-q||};
            Set f_{F}(p) = max (f_{F}(p), ωf_{F}^{\hat{Ω}q}(I^{t}(p)));
            Set f_{B}(p) = max (f_{B}(p), ωf_{B}^{\hat{Ω}q}(I^{t}(p)));
      end for
      Set foreground loss l_{F}(p) = max (0,γ − f_{F}(p));
      Set background loss l_{B}(p) = max (0,γ − f_{B}(p));
      if (l_{F}(p) < T_{F}^{low}) && (l_{B}(p) > T_{B}^{high}) then
            Set L^{t}(p) to foreground;
      else if (l_{F}(p) > T_{F}^{high}) && (l_{B}(p) < T_{B}^{low}) then
            Set L^{t}(p) to background;
      else
            Set L^{t}(p) to unknown;
      end if
end for
```
(g) wherein the thresholds and equations are more particularly set out in the specification hereto.
